(19) United States
(12) Patent Application Publication
(10) Pub. No.: US 2022/0046672 A1
(43) Pub. Date: Feb. 10, 2022

(54) METHOD, DEVICE AND COMPUTER READABLE MEDIUM FOR MULTI-TRP TRANSMISSION

(71) Applicant: NEC CORPORATION, Tokyo (JP)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 17/413,044

(22) PCT Filed: Dec. 14, 2018
(86) PCT No.: PCT/CN2018/121297

§ 371 Date: Jun. 11, 2021

(51) Int. Cl. H04W 72/12

(52) U.S. Cl. CPC H04W 72/1268; H04W 72/1289

(57) ABSTRACT

Embodiments of the present disclosure relate to methods, devices and computer readable media for multi-Transmission and Reception Point (TRP) transmission. In example embodiments, a method implemented in a terminal device includes determining a first link direction for a symbol, based on a first indication received via a first TRP coupled with a network device, the first link direction indicating a direction of a first transmission to be performed in the symbol between the terminal device and the network device via the first TRP. The method further includes determining a second link direction for the symbol, based on a second indication received via a second TRP coupled with the network device, the second link direction indicating a direction of a second transmission to be performed in the symbol between the terminal device and the network device via the second TRP. The method further includes determining, based on the first and second link directions, a target transmission to be performed in the symbol from the first and second transmissions.

### TECHNICAL FIELD

Embodiments of the present disclosure generally relate to the field of communication, and in particular, to methods, devices and computer readable media for multi-Transmission and Reception Point (TRP) transmission.

### BACKGROUND

Communication technologies have been developed in various communication standards to provide a common protocol that enables different wireless devices to communicate on a municipal, national, regional, and even global level. An example of an emerging communication standard is new radio (NR), for example, 5G radio access. NR is a set of enhancements to the Long Term Evolution (LTE) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

In NR, a network device (e.g., gNodeB) may be equipped with multiple TRPs or antenna panels. That is, the network device can communicate with a terminal device (e.g., user equipment, UE) via one or more of the multiple TRPs. Various indications may be transmitted to the terminal device via different TRPs to indicate the terminal device of slot formats and resources configured for scheduled transmissions. Therefore, there is a need to specify the issues regarding link direction confliction and uplink resource confliction caused by indications from different TRPs.

### SUMMARY

In general, example embodiments of the present disclosure provide methods, devices and computer readable media for multi-TRP transmission.

In a first aspect, there is provided a method implemented at a terminal device. The method comprises determining a first link direction for a symbol, based on a first indication received via a first TRP coupled with a network device, the first link direction indicating a direction of a first transmission to be performed in the symbol between the terminal device and the network device via the first TRP; determining a second link direction for the symbol, based on a second indication received via a second TRP coupled with the network device, the second link direction indicating a direction of a second transmission to be performed in the symbol between the terminal device and the network device via the second TRP; and determining, based on the first and second link directions, a target transmission to be performed in the symbol from the first and second transmissions.

In a second aspect, there is provided a method implemented at a terminal device. The method comprises receiving an indication from a network device, the terminal device being communicating with the network device via a first TRP coupled with the network device; and in response to determining that the indication indicates activation of a second TRP coupled with the network device, performing communication with the network device via the second TRP.

In a third aspect, there is provided a method implemented at a network device. The method comprises determining an indication to be transmitted to a terminal device, the terminal device being communicating with the network device via a first TRP coupled with the network device and the indication indicating activation of a second TRP coupled with the network device; transmitting the indication to the terminal device; and performing communication with the terminal device via the second TRP.

In a fourth aspect, there is provided a terminal device. The terminal device includes a processor; and a memory coupled to the processing unit and storing instructions thereon, the instructions, when executed by the processing unit, causing the device to perform the method according to the first aspect.

In a fifth aspect, there is provided a terminal device. The terminal device includes a processor; and a memory coupled to the processing unit and storing instructions thereon, the instructions, when executed by the processing unit, causing the device to perform the method according to the second aspect.

In a sixth aspect, there is provided a network device. The network device includes a processor; and a memory coupled to the processing unit and storing instructions thereon, the instructions, when executed by the processing unit, causing the device to perform the method according to the third aspect.

In a seventh aspect, there is provided a computer readable medium having instructions stored thereon, the instructions, when executed on at least one processor, causing the at least one processor to carry out the method according to the first aspect.

In an eighth aspect, there is provided a computer readable medium having instructions stored thereon, the instructions, when executed on at least one processor, causing the at least one processor to carry out the method according to the second aspect.

In a ninth aspect, there is provided a computer readable medium having instructions stored thereon, the instructions, when executed on at least one processor, causing the at least one processor to carry out the method according to the third aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a schematic diagram illustrating a process for multi-TRP transmission;

FIG. 3 shows a flowchart of an example method in accordance with some embodiments of the present disclosure;

FIG. 4A shows a schematic diagram illustrating a link direction collision according to some embodiments of the present disclosure;

FIG. 4B shows a schematic diagram illustrating handling of a link direction collision according to some embodiments of the present disclosure;

FIG. 4C shows a schematic diagram illustrating handling of a link direction collision according to some embodiments of the present disclosure;

FIG. 5 shows a schematic diagram of partially dropping scheduled uplink transmission according to some embodiments of the present disclosure;

FIG. 6 shows a schematic diagram of dropping scheduled downlink transmission according to some embodiments of the present disclosure;

FIG. 7A shows a schematic diagram illustrating an UL confliction according to some embodiments of the present disclosure;

FIG. 7B shows a schematic diagram illustrating handling of an UL confliction according to some embodiments of the present disclosure;

FIG. 7C shows a schematic diagram illustrating handling of an UL confliction according to some embodiments of the present disclosure;

FIG. 8 is a schematic diagram illustrating a process 800 for multi-TRP transmission according to some embodiments of the present disclosure;

FIG. 9 is a schematic diagram illustrating multi-TRP transmission according to some embodiments of the present disclosure;

FIG. 10 shows a flowchart of an example method in accordance with some embodiments of the present disclosure;

FIG. 11 shows a flowchart of an example method in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

It has been agreed that in NR eMIMO, the maximum supported number of NR-Physical Downlink Control Channels (PDCCHs) corresponding to scheduled NR-Physical Downlink Shared Channels (PDSCHs) that a UE can be expected to receive in a single slot is 2 on a per component carrier basis in case of one bandwidth part for the component carrier. Regarding multiple-PDCCH based multi-TRP/panel downlink transmission, several enhancements need to be studied, including PDSCH scheduling restriction/indication, configurations and monitoring of multiple PDCCH, PDCCH/PDSCH processing/preparation timing for supporting multiple PDCCH, etc.

As mentioned above, the UE may receive different indications from multiple TRPs coupled with a same gNodeB. Based on the indication from one of the multiple TRPs, the UE may determine that one or more symbol are configured for uplink; whereas based on indication from another one of the multiple TRPs, the UE may determine that the one or more symbol are configured for downlink. As such, a link direction collision occurs for the one or more symbol. As another example, the UE may determine two uplink resources based on two indications from two TRPs coupled with the same gNodeB, respectively. The two uplink resources may be overlapped with each other. As such, an uplink confliction occurs.

Embodiments of the present disclosure provide a solution for multi-TRP transmission, in order to solve the problems above and one or more of other potential problems. In an aspect, rules for handling the link direction collision and UL confliction are proposed to resolve conflictions caused by indications from different TRPs. In a further aspect, the way of activating and deactivating a TRP is proposed.

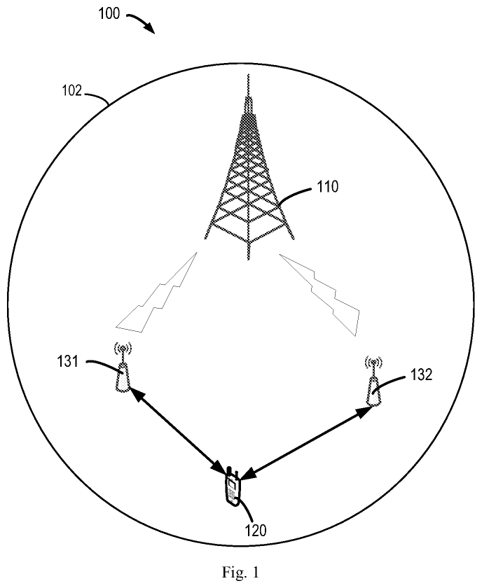

Principle and implementations of the present disclosure will be described in detail below with reference to FIGS. 1-12.

FIG. 1 shows an example communication network 100 in which embodiments of the present disclosure can be implemented. The network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing embodiments of the present disclosure. Although not shown, it is to be understood that one or more terminal devices may be located in the cell 102 and served by the network device 110.

In the communication network 100, the network device 110 can communicate data and control information to the terminal device 120 and the terminal device 120 can also communication data and control information to the network device 110. A link from the network device 110 to the terminal device 120 is referred to as a downlink (DL) or a forward link, while a link from the terminal device 120 to the network device 110 is referred to as an uplink (UL) or a reverse link.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

As shown in FIG. 1, the network device 110 is couple with two TRPs 131 and 132 and may communicate with the terminal device 120 via the two TRPs 131 and 132. In the following, the TRP 131 may be also referred to as the first TRP, while the TRP 132 may be also referred to as the second TRP. The first and second TRPs 131 and 132 may be included in a same serving cell (such as, the cell 102 as shown in FIG. 1) or different serving cells provided by the network device 110. Although some embodiments of the present disclosure are described with reference to the first and second TRPs 131 and 132 within a same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In embodiments, the terminal device 120 may receive different types of indications about slot formats and configured resources from the network device 110 via the two TRPs 131 and 132. For example, the parameters “TDD-UL-DL-ConfigurationCommon”, or “TDD-UL-DL-ConfigDedicated” in a Radio Resource Control (RRC) signaling may specify a slot format, and a slot format indicator (SFI), which is a downlink control information in format 2_0, may also indicate the format of a current slot (and/or a future slot). In the present disclosure, for purpose of discussion, indications comprised in the parameters “TDD-UL-DL-Configuration Common” and “TDD-UL-DL-ConfigDedicated” and the SFI can be considered as having a first indication type. Accordingly, symbols configured by indications of this type for uplink will be referred to as “SFI U” symbols and symbols configured by the indications of this type for downlink will be referred to as “SFI D” symbols. The remaining symbols, neither configured as “SFI D” nor “SFI U”, are flexible symbols.

Higher layer signaling such as RRC signaling may configure, to the terminal device 120, resources for PDCCH, or a PDSCH, or a Channel State Information-Reference Signal (CSI-RS) and resources for sounding reference signal (SRS), or Physical Uplink Control Channel (PUCCH), or Physical Uplink Shared Channel (PUSCH), or Physical Random Access Channel (PRACH). Thus, symbols corresponding to resources for PDCCH, or a PDSCH, or a CSI-RS are configured for downlink, and symbols corresponding to resources for SRS, or PUCCH, or PUSCH, or PRACH are configured for uplink. In the present disclosure, for purpose of discussion, indications from higher layer for resource configuration will be considered as having a second indication type. Accordingly, symbols corresponding to higher-layer configured PDCCH, or a PDSCH, or a CSI-RS will be referred to as “RRC D” symbols and symbols corresponding to higher-layer configured SRS, or PUCCH, or PUSCH, or PRACH will be referred to as “RRC U” symbols.

DCI in formats other than DCI format 2_0 may also indicate to the terminal device 120 of resources for scheduled transmission. In the present disclosure, for purpose of discussion, indications in DCI formats other than DCI format 20 will be considered as having a third indication type. Accordingly, symbols scheduled for uplink by DCI formats other than DCI format 2_0 will be referred to as “Dynamic U” symbols and symbols scheduled for downlink by DCI formats other than DCI format 2_0 will be referred to as “Dynamic D” symbols.

If the backhaul between the two TRPs 131 and 132 is not ideal, the network device 110 may not be able to coordinate the indications to the terminal device 120 via the two TRPs 131 and 132 timely. As a result, a link direction collision or UL confliction may occur.

In some cases, for certain symbols, the terminal device 120 may determine that those symbols are for uplink based on an indication (of any of the first, second and third indication types) received via the first TRP 131 and determine that the same symbols are for downlink based on another indication (of any of the first, second and third indication types) received via the second TRP 132. In this event, a link direction collision occurs for those symbols. The terminal device 120 may need to select from uplink and downlink a target link direction for transmission to be performed in those symbols.

In some cases, the terminal device 120 may determine an uplink resource based on an indication (of any of the second or third indication type) received via the first TRP 131 and determine another uplink resource based on another indication (of any of the second or third indication type) received via the second TRP 132. The two uplink resources may be configured for communication between the network device 110 and terminal device 120 via the first TRP 131 and the second TRP 132, respectively. If the two resources are overlapped with each other, an UL confliction occurs.

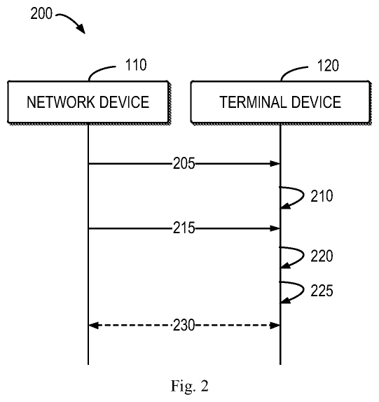

Implementations of the present disclosure will be described in detail below with reference to FIGS. 2-11 to illustrate how to handle the link direction collision and UL confliction. FIG. 2 is a schematic diagram illustrating a process 200 for multi-TRP transmission. The network device 110 transmits 205 a first indication to the terminal device 120 via the first TRP 131. The terminal device 120 may determine 210 a slot format or a resource based on the first indication. The network device 110 transmits 215 a second indication to the terminal device 120 via the second TRP 131. The terminal device 120 may determine 220 another slot format or another resource based on the second indication. If a link direction collision or UL confliction occurs, the terminal device 120 determines 225 a target transmission according to the rules for handling link direction collision and UL confliction which are detailed below. In some embodiments, if resources for the target transmission are configured, the terminal device 120 may perform 230 the target transmission.

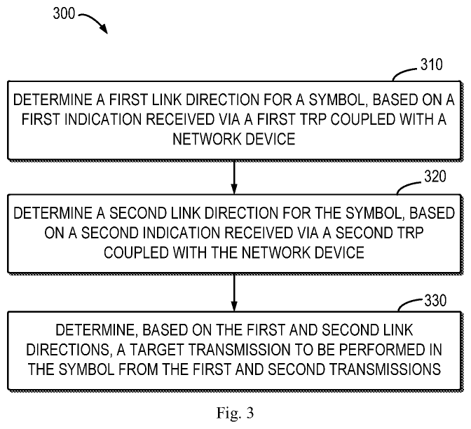

FIG. 3 illustrates a flowchart of an example method 300 in accordance with some embodiments of the present disclosure. The method 300 can be implemented at the terminal device 120 shown in FIG. 1. It is to be understood that the method 300 may include additional blocks not shown and/or may omit some blocks as shown, and the scope of the present disclosure is not limited in this regard. For the purpose of discussion, the method 300 will be described with reference to FIG. 1.

At block 310, the terminal device 120 determines a first link direction for a symbol, based on a first indication received via the first TRP 131 coupled with the network device 110. The first link direction indicates a direction of a first transmission to be performed in the symbol between the terminal device 120 and the network device 110 via the first TRP 131.

At block 320, the terminal device 120 determines a second link direction for the symbol, based on a second indication received via a second TRP 132 coupled with the network device 110. The second link direction indicates a direction of a second transmission to be performed in the symbol between the terminal device 120 and the network device 110 via the second TRP 132. At least one of the first and second link directions is uplink.

In cases where one of the first and second link directions is uplink and the other one is downlink, i.e. the link direction collision, the first and second indication may be of any of the first, second and third types as described above. In cases where both the first and second link directions are uplink, i.e. the UL confliction, the first and second indications may be of any of the second and third indication types.

At block 330, the terminal device 120 determines, based on the first and second link directions, a target transmission to be performed in the symbol from the first and second transmissions. The terminal device 120 may determine the target transmission based on at least one of indication types of the first and second indications and priorities of the first and second TRPs 131 and 132.

In some embodiments, if a priority of the first TRP 131 is higher than that of the second TRP 132, the terminal device 120 may determine the first transmission as the target transmission. For example, if the first TRP 131 is the reference TRP, the terminal device 120 may determine to follow the indication from the first TRP 131. This approach is applicable to both the link direction collision and the UL confliction. The reference TRP may be explicitly configured by higher layer signaling. The reference TRP can be also implicitly determined by an ID associated with TRP, e.g., the lowest ID value.

In some embodiments, the first indication is comprised in DCI to indicate a first resource, which means the first indication is of the third indication type, and the second indication is comprised in RRC signaling to indicate a second resource, which means the second indication is of the second indication type, and the first resource overlaps the second resource over the symbol. In this case, the terminal device 120 may determine the first transmission as the target transmission. That is, the terminal device 120 may determine to prioritize the DCI in formats other than DCI format 2_0. This approach is applicable to both the link direction collision and the UL conflict.

In some embodiments, the first link direction is different from the second link direction, i.e. the link direction collision. If the first indication indicates a slot format of a slot including the symbol (for example, the first indication may be of the first indication type) and the second indication indicates a resource (for example, the second indication may be of the second or third indication type), the time domain of which includes the symbol, the terminal device 120 may then determine the first transmission as the target transmission. This means that indications of the first indication type have a higher priority than indications of the second and third indication types.

In some embodiments, the first indication is comprised in first DCI to indicate a first resource, and the second indication is comprised in second DCI to indicate a second resource, and the first resource overlaps the second resource over the symbol. In this case, the terminal device 120 may determine the target transmission based on timing information related to the first and second DCI. For example, the terminal device 120 may determine first timing information associated with the first DCI and second timing information associated with the second DCI, and determine the target transmission based on the first and second timing information.

In some embodiments, the terminal device 120 may determine the first timing information based on at least one of the following: a starting symbol of the first DCI; an ending symbol of the first DCI; decoding latency of the first DCI; a starting symbol of the first resource; and the duration of the first resource. The second timing information may be determined correspondingly. This approach is applicable to both the link direction collision and the UL confliction and will be described in detail below.

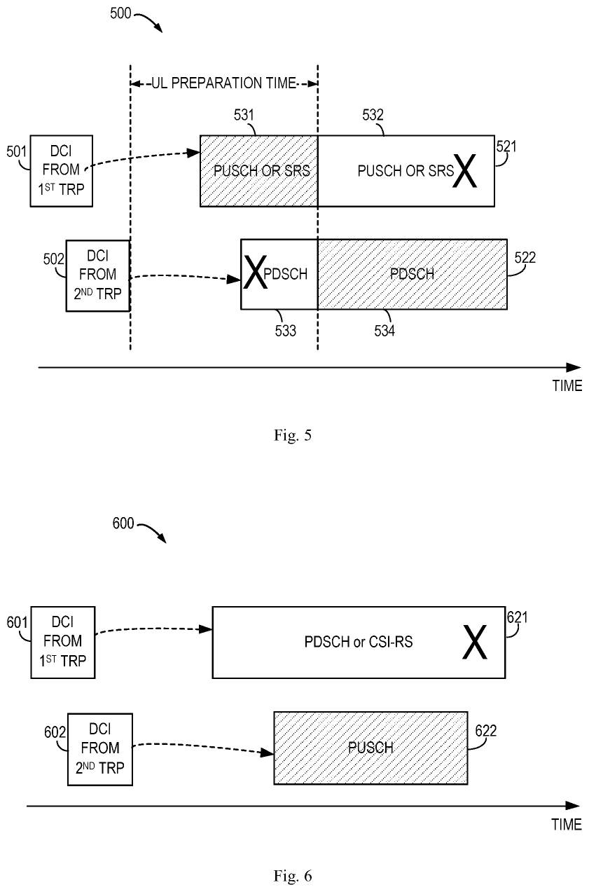

In some embodiments, the first indication is comprised in a first DCI to indicate downlink resources for the first transmission and the second indication is comprised in second DCI to indicate uplink resources for the second transmission, which means a link direction collision. In this case, if the first transmission is determined as the target transmission and starting of the second transmission is prior to starting of the first transmission, the terminal device 120 may perform the second transmission on the uplink resource during a time period associated with the terminal device 120 and performs reception on the downlink resource from the network device 110 after the time period. The time period may be UL preparation time which is related to the processing capability of the terminal device 120. Such embodiments will be described below in detail with reference to FIG. 5.

In some embodiments, if both the first and second transmissions are uplink transmissions, which means an UL confliction, the terminal device 120 may determine the target transmission based on information to be transmitted via the first TRP 131 and the second TRP 132, respectively. For example, the terminal device 120 may first determine a first information type of first information to be comprised in the first transmission and a second information type of second information to be comprised in the second transmission. The terminal device 120 may then determine the target transmission based on the first and second information types.

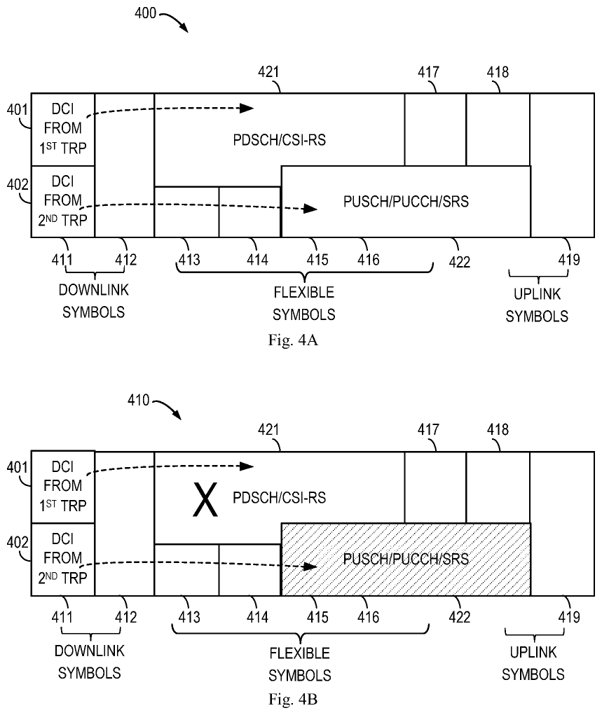

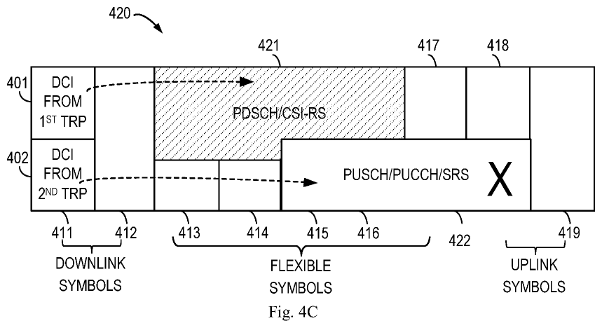

In some embodiments, if the first information type is of control information and the second information type is of data information, the terminal device 120 may determine the first transmission as the target transmission. That is, control information may have a higher priority than data information. Predefined priories may be given to different types of information. Such embodiments will be described below in detail with reference to FIGS. 4A-4C.

As mentioned above, a link direction collision may occur in some cases. Detail descriptions of how to handle the link direction collision now are made with reference to Table 1 and FIGS. 4A-4C, 5 and 6.

Table 1 summarizes examples of link direction collision under multi-TRP and the corresponding behavior of the terminal device 120. In some scenarios, the multiple TRPs coupled with the network device may be not equivalent to each other and one of the multiple TRPs may be used as a reference TRP (for short, Ref TRP). For the purpose of discussion, Table 1 will be described with reference to FIG. 1 and the first TRP 131 may be considered as the Ref TRP.

In Table 1, the first column shows the symbol types determined based on indications from the reference (Ref) TRP and the second column shows symbol types determined based on indications from the other TRP. As can be seen, the symbol types may include “SFI D”, “SFI U”, “RRC D”, “RRC U”, “Dynamic D” and “Dynamic U” as described above. The third column shows the corresponding behavior of the terminal device. The first column may also show the symbol types determined based on cell-specific indications which may be not explicitly associated with any TRP, and the Ref TRP is consistent with these cell-specific indications.

TABLE 1
Examples of link direction collision under multi-TRP

| Symbol type according to | Symbol type according | |
|---|---|---|
| Ref TRP | to the other TRP | Behavior of the terminal device |
| SFI D | SFI U | Error case |
| | RRC U | Drop U |
| | Dynamic U | Error case, or follow ref TRP |
| RRC D | SFI U | Error case |
| | RRC U | Follow ref TRP |
| | Dynamic U | Follow ref TRP, or prioritize Dynamic U |
| Dynamic D | SFI U | Error case |
| | RRC U | Drop U |
| | Dynamic U | As described above with reference to |
| | | FIG. 2 and detailed below |
| SFI U | SFI D | Error case |
| | RRC D | Drop D |
| | Dynamic D | Error case, or follow ref TRP |
| RRC U | SFI D | Error case |
| | RRC D | Follow ref TRP |
| | Dynamic D | Follow ref TRP, or prioritize Dynamic D |
| Dynamic U | SFI D | Error case |
| | RRC D | Follow ref TRP |
| | Dynamic D | As described above with reference to |
| | | FIG. 2 and detailed below |

For purpose of discussion, description is now made with respect to the example with “RRC D” and “Dynamic U” as shown in Table 1. In some embodiments, for the one or more symbols for which link direction collision occurs, the terminal device 120 may determine the link direction of the one or more symbols based on the priorities of the two TRPs. For example, the terminal device 120 may follow the Ref TRP which has a higher priority, as indicated by “Follow ref TRP” in Table 1. In some other embodiments, for the one or more symbols for which link direction collision occurs, the terminal device 120 may determine the link direction of the one or more symbols based on the types of indications. For example, the terminal device 120 may determine to follow the indication of the third indication type, as indicated by “prioritize Dynamic U” in Table 1. As such, in this example, the link direction of the one or more symbol will be determined as uplink. This approach enables more flexible and dynamic scheduling from the DCI.

It is to be noted that due to the characteristics of for example SFI, DCI and RRC signaling, some of the examples in Table 1 are indicated as “error case”, and for these examples indicated as “error case” the terminal device 120 does not expect that such indications are indicated by the network device 110. Further, if ideal backhaul is maintained between the two TRPs, all the examples shown in Table 1 may be considered as “error case”.

For the examples of Table 1 with “Dynamic D” and “Dynamic U”, embodiments will be described in detail with reference to FIG. 4A-4C. FIG. 4A shows a schematic diagram 400 illustrating a link direction collision according to some embodiments of the present disclosure.

FIG. 4A shows nine symbols 411-417, wherein the symbols 411-412 are configured as downlink symbols and symbols 418-419 are configured as uplink symbols. Symbols 413-417 are flexible symbols. Flexible symbols can be for either downlink or uplink based on a DCI indication. For example, a symbol may be considered as a flexible symbol for the following instances: 1) when there is no TDD-DL-UL-ConfigurationCommon or TDD-DL-UL-ConfigDedicated and no SFI-DCI (DCI format 2_0); 2) when configured as a flexible symbol by TDD-DL-UL-ConfigurationCommon or TDD-DL-UL-ConfigDedicated and no SFI-DCI; 3) when configured as flexible by both TDD-DL-UL-ConfigurationCommon or TDD-DL-UL-ConfigDedicated and SFI-DCI.

If there is an ideal backhaul between the first TRP 131 and the second TRP 132, the network device 110 will coordinate between the two TRPs and any link direction collision will not occur. That is, for a set of symbols of a slot that the terminal device (e.g. UE) considers as flexible symbols, the terminal device is not expected to transmit in the set of symbols of the slot from the UE to one TRP and to receive in the set of symbols of the slot from another TRP, based on the indication of DCI in the same serving cell.

For an unideal backhaul, a link direction collision may occur due to indication of DCI received via different TRPs. As shown in FIG. 4A, DCI 401 received via the first TRP 131 indicates a downlink resource 421 for a first transmission between the network device 110 and the terminal device 120 via the first TRP 131, and DCI 402 received via the second TRP 132 indicates an uplink resource 422 for a second transmission between the network device 110 and the terminal device 120 via the second TRP 132. The downlink resource 421 and the uplink resource 422 are overlapped with each other over the symbols 415-416, which are flexible symbols. Thus, the terminal device 120 may need to handle the link direction collision. For example, the terminal device 120 may determine from the downlink resource 421 and the uplink resource 422, a target resource to perform communication with the network device 110.

FIG. 4B shows a schematic diagram 410 illustrating handling of a link direction collision according to some embodiments of the present disclosure. FIG. 4C shows a schematic diagram 420 illustrating handling of a link direction collision according to some embodiments of the present disclosure.

As described above, in some embodiments, the terminal device 120 may determine the target resource based on a predefined timing priority. The predefined timing priority may be related to at least one of starting/ending DCI symbols, DCI decoding latency, starting symbols and/or duration of scheduled transmission. For example, if the starting symbol of DCI 401 precedes the starting symbol of DCI 402, the downlink resource 421 will be determined as the target resource and the terminal device 120 will perform the scheduled transmission on the resource 421.

As another example, if decoding of the DCI 402 is completed before the decoding of the DCI 401, then the terminal device 120 may determine the uplink resource 422 as the target resource as schematically shown in FIG. 4B. Then the terminal device 120 may perform the scheduled transmission on the resource 422.

As a further example, as shown in FIG. 4C, the starting symbol 413 of the downlink resource 421 precedes the starting symbol 415 of the uplink resource 422. The terminal device 120 may thus determine the downlink resource 421 as the target resource.

In some embodiments, the terminal device 120 may determine the target resource based on priorities of the TRPs. For example, the terminal device 120 may be configured to follow the reference TRP, for example, the first TRP 131. Priorities of the TRPs may be determined based on other criterions, for example, TRP IDs. The TRP with a lower TRP ID value can have a higher priority.

The transmission which is not selected by the terminal device 120 may be dropped partially or as a whole. FIG. 5 shows a schematic diagram 500 of partially dropping scheduled uplink transmission according to some embodiments of the present disclosure. As shown in FIG. 5, DCI 501 received via the first TRP 131 indicates an uplink resource 521 and DCI 502 received via the second TRP 132 indicates a downlink resource 522. The downlink resource 522 is determined by the terminal device 120 as the target resource.

As shown, the starting symbol of the uplink resource 521 precedes the starting symbol of the downlink resource 522. In such cases, the terminal device 120 may partially drop the scheduled transmission on the uplink resource 521. An UL preparation time which is determined by the processing capability of the terminal device 120 is required for uplink transmission. As a result, uplink transmission may be performed on the first part 531 of the resource 521 within the UL preparation time. After the UL preparation time elapses, the terminal device 120 may cancel the transmission on the remaining part 532 of the resource 521 and perform reception on the remaining part 534 of the downlink resource 522. As such, reception on the first part 533 of the resource 522 is not performed.

FIG. 6 shows a schematic diagram 600 of dropping scheduled downlink transmission according to some embodiments of the present disclosure. As shown in FIG. 6, DCI 601 received via the first TRP 131 indicates a downlink resource 621 and DCI 602 received via the second TRP 132 indicates an uplink resource 622. The uplink resource 622 is determined by the terminal device 120 as the target resource. Different to from the embodiment shown in FIG. 5, scheduled transmission on the downlink resource 621 is dropped at least in the symbols of overlapped resources and scheduled uplink transmission is perform on the resource 622.

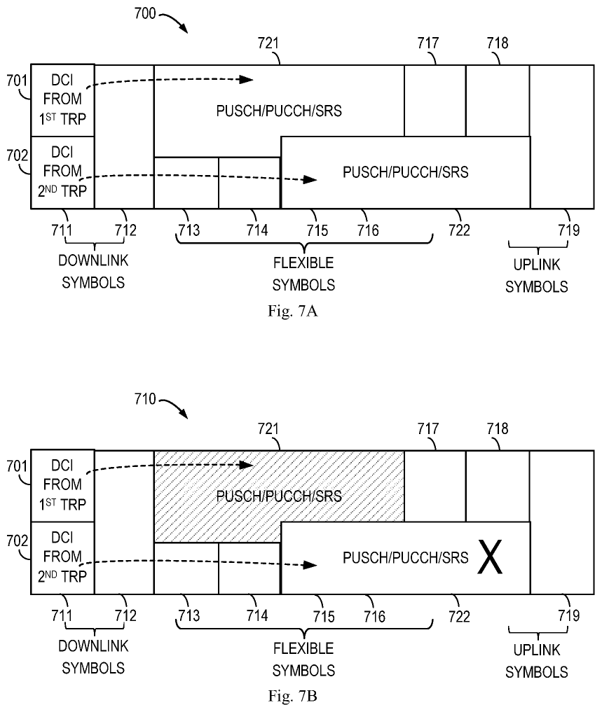

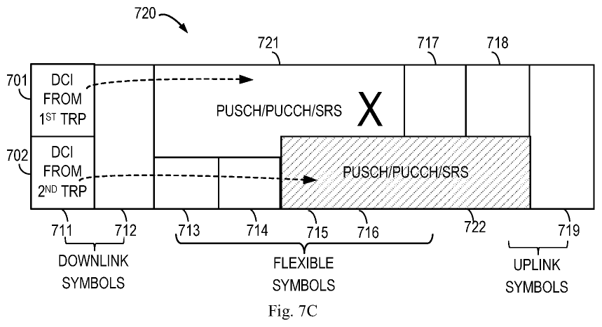

As mentioned above, an UL confliction may occur in some cases. Detail descriptions of how to handle the UL confliction now are made with reference to Table 2 and FIGS. 7A-7C.

Table 2 summarizes examples of UL confliction under multi-TRP and the corresponding behavior of the terminal device 120. As mentioned above, in some scenarios, the multiple TRPs coupled with the network device may be not equivalent to each other and one of the multiple TRPs may be used as a reference TRP (for short, Ref TRP). For the purpose of discussion, Table 2 will be described with reference to FIG. 1 and the first TRP 131 may be considered as the Ref TRP.

In Table 2, the first column shows the symbol types determined based on indications from the Ref TRP and the second column shows symbol types determined based on indications from the other TRP. As can be seen, the symbol types may include “RRC U” and “Dynamic U” as described above. The third column shows the corresponding behavior of the terminal device 120.

TABLE 2
Examples of UL confliction under multi-TRP

| Symbol type according to | Symbol type according | |
|---|---|---|
| Ref TRP | to the other TRP | Behavior of the terminal device |
| RRC U | RRC U | Rule 1: follow Ref TRP |
| | Dynamic U | Rule 2: follow prioritized UL type |
| Dynamic U | RRC U | Rule 3: prioritize Dynamic U to RRC U |
| | Dynamic U | As described above with reference to FIG. |
| | | 2 and detailed below |

For the example with “RRC U” according to the first TRP 131 and “RRC U” according to the second TRP 132, the example with “RRC U” according to the first TRP 131 and “Dynamic U” according to the second TRP 132, and the example with “Dynamic U” according to the first TRP 131 and “RRC U” according to the second TRP 132, different rules may be applied in different embodiments. The rule 1 and rule 3 as shown is similar with those described with respect to the link direction collision. Rule 2 will be described below.

It is to be noted that if ideal backhaul is maintained between the two TRPs, all the examples shown in Table 2 may be considered as “error case”.

For the example with “Dynamic U” according to the first TRP 131 and “Dynamic U” according to the second TRP 132, embodiments will be described in detail with reference to FIG. 7A-7C. FIG. 7A shows a schematic diagram 700 illustrating an UL confliction according to some embodiments of the present disclosure.

FIG. 7A shows nine symbols 711-717, wherein the symbols 711-712 are configured as downlink symbols and symbols 718-719 are configured as uplink symbols. Symbols 713-717 are flexible symbols. Flexible symbols can be for either downlink or uplink based on a DCI indication.

If there is an ideal backhaul between the first TRP 131 and the second TRP 132, the network device 110 will coordinate between the two TRPs and any UL confliction will not occur. That is, the terminal device is not expected to transmit on overlapped UL resources to different TRPs.

For an unideal backhaul, an UL confliction may occur due to indication of DCI received via different TRPs. As shown in FIG. 7A, DCI 701 received via the first TRP 131 indicates an uplink resource 721 for a first transmission between the network device 110 and the terminal device 120 via the first TRP 131, and DCI 702 received via the second TRP 132 indicates an uplink resource 722 for a second transmission between the network device 110 and the terminal device 120 via the second TRP 132. The uplink resource 721 and the uplink resource 722 are overlapped with each other over the symbols 715-716. Thus, the terminal device 120 may need to handle the UL confliction. For example, the terminal device 120 may determine from the uplink resource 721 and the uplink resource 722, a target resource to perform uplink transmission to the network device 110.

FIG. 7B shows a schematic diagram 710 illustrating handling of an UL confliction according to some embodiments of the present disclosure. FIG. 7C shows a schematic diagram 720 illustrating handling of an UL confliction according to some embodiments of the present disclosure.

Similar as described with respect to link direction collision, in some embodiments, the terminal device 120 may determine the target resource based on a predefined timing priority. The predefined timing priority may be related to at least one of starting/ending DCI symbols, DCI decoding latency, starting symbols and/or durations of scheduled transmission. For example, if the starting symbol of DCI 701 precedes the starting symbol of DCI 702, the uplink resource 721 will be determined as the target resource and the terminal device 120 will perform the scheduled uplink transmission on the resource 721.

As another example, as shown in FIG. 7B, the starting symbol 713 of the uplink resource 721 precedes the starting symbol 715 of the uplink resource 722. In this case, the terminal device 120 may determine the downlink resource 721 as the target resource.

As a further example, if decoding of the DCI 702 is completed before the decoding of the DCI 701, then the terminal device 120 may determine the uplink resource 722 as the target resource as schematically shown in FIG. 7B. Then the terminal device 120 may perform the scheduled transmission on the resource 722.

In some embodiments, the terminal device 120 may determine the target resource based on priorities of the TRPs. For example, the terminal device 120 may be configured to follow the reference TRP, for example, the first TRP 131. Priorities of the TRPs may be determined based on other criterions, for example, TRP IDs.

In some embodiments, the terminal device 120 may determine the target resource based on information types of information to be transmitted, which are herein referred to as UL types only for purpose of discussion. For the example with “Dynamic U” according to the first TRP 131 and “Dynamic U” according to the second TRP 132, UL types may include: PRACH, PUCCH with acknowledge/negative acknowledge (ACK/NACK), PUCCH with ACK/NACK/Scheduling Request (SR), PUSCH with CSI report, PUSCH, SRS. As described above with reference to FIG. 2, control information may have a higher priority than data information.

Just as an example, priorities of different UL types may be defined as: PRACH>PUCCH with ACK/NACK/SR or PUSCH with ACK/NACK>PUSCH with CSI report>PUSCH>SRS, including aperiodic SRS (A-SRS), periodic SRS (P-SRS) and semi-persistent SRS (SP-SRS). Still refer to FIG. 7A, if the uplink resource 721 is configured for transmission of PUCCH with ACK/NACK/SR and the uplink resource 722 is configured for transmission of PUSCH with CSI report, then the terminal device 120 may determine the uplink resource 721 as the target resource.

In the example priorities above, UL types of PUCCH with ACK/NACK/SR and PUSCH with ACK/NACK has the same priority. It can be further specified that for example, the UL type of PUCCH with ACK/NACK/SR has a higher priority than the UL type of PUSCH with ACK/NACK. Alternatively, it can be specified that for example, the UL type of PUSCH with ACK/NACK has a higher priority than the UL type of PUCCH with ACK/NACK/SR.

For the examples of Table 2 with “RRC U”, UL types may additionally include PUCCH with CSI report. Example priorities of different UL types for these examples may be defined as: PRACH>PUCCH with ACK/NACK/SR or PUSCH with ACK/NACK>PUSCH with CSI report or PUCCH with CSI report>PUSCH>SRS.

Similarly, it can be further specified that for example, the UL type of PUCCH with ACK/NACK/SR has a lower priority than the UL type of PUSCH with ACK/NACK. Additionally, it can be specified that for example, the UL type of PUSCH with CSI report has a higher priority than the UL type of PUCCH with CSI report.

In the examples above, the PUCCH resources for SR, and PRACH resources may be configured associated only with one TRP, rather than two TRPs. For example, RRC signaling may configure the PUCCH resources for SR and PRACH resources to be only associated with the reference TRP, but not associated with the other TRP. The TRP associated with the PUCCH resources for SR and PRACH resources can be explicitly configured or implicitly determined by RRC signaling. If implicitly determined, the TRP with lower ID can be associated with the configured PUCCH resources for SR and PRACH resources.

It is to be understood that the above priorities are described for illustration purpose only without any limitation. A person skilled in the art may envisage other priority order for different UL types.

A plurality of rules for handling the link direction collision and UL confliction have been described above. These rules are applicable to the scenario of carrier aggregation (CA). In the scenario of CA, in addition to the link direction collision and/or UL confliction caused by different TRPs, link direction collision and/or UL confliction caused by different component carriers (CCs), for example, CC₁ to CCₙ may also occur. In some embodiments, the rules described above may be firstly applied among different CCs for the first TRP 131 and applied among different CCs for the second TRP 132. Then the rules are secondly applied among different TRPs. This manner may be considered as inter-CC first and inter-TRP second.

In some other embodiments, the rules described above may be firstly applied among different TRPs for each of the CC₁ to CCₙ. Then the rules are applied among different CCs (CC₁ to CCₙ). This manner may be considered as inter-TRP first and inter-CC second.

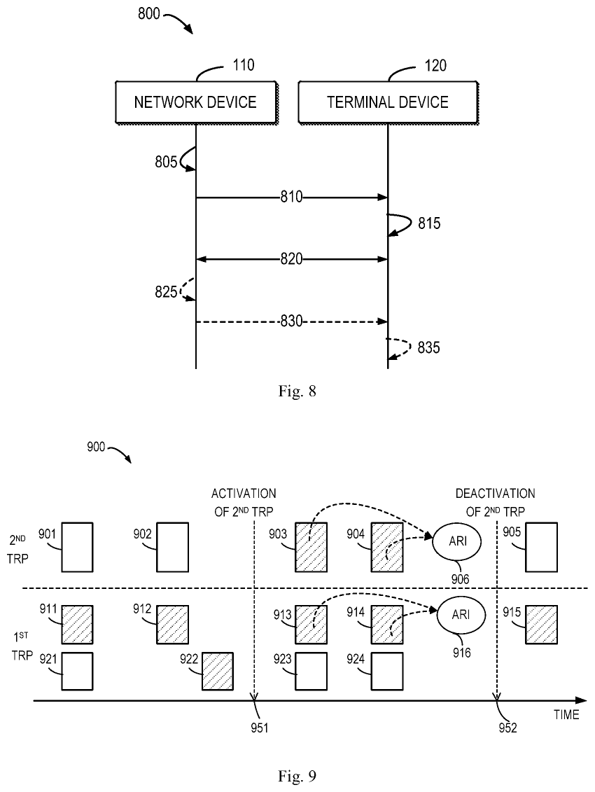

Aspects regarding the link direction collision and UL confliction have been described above. Other aspects regarding multi-TRP transmission will be described below with reference to FIGS. 8-11. FIG. 8 is a schematic diagram illustrating a process 800 for multi-TRP transmission according to some embodiments of the present disclosure. For the purpose of discussion, the process 800 will be described with reference to FIG. 1.

For the example environment shown in FIG. 1, one of the two TRPs 131 and 132, for example, the reference TRP or the first TRP 131, is activated since initial access or RRC setup, whereas the other TRP, i.e. the second TRP 132 is not activated. Prior to activation of a TRP, RRC signaling may indicate a set of configurations related to the TRP. For example, the RRC configuration may include any of PDCCH configurations, PDSCH configurations, CSI measurement configurations, PUCCH configurations and SRS configurations for a TRP. Refer to FIG. 9, which is a schematic diagram 900 illustrating multi-TRP transmission according to some embodiments of the present disclosure. Before the activation of the second TRP 132 at time 951, the terminal device 120 may communicate with the network device 110 only via the first TRP 131. The terminal device 120 will not monitor PDCCH on the control resource sets (CORESETs) 901 and 902 configured associated with the second TRP 132 since it is not activated. The terminal device 120 will monitor PDCCH on the CORESETs 911, 912 and 922 (CORESET 921 may be dropped due to collision.), which are associated with the activated first TRP 131.

Still refer to FIG. 8. The network device 110 determines 805 an indication to be which is used to indicate activation of the second TRP 132. Then the network device 110 transmits 810 the indication to the terminal device 120. The terminal device 120 determines 815 that the indication indicates activation of the second TRP 132. After a predetermined period of time from receiving this indication, the RRC configurations for the second TRP takes effect, and the terminal device 120 communicates 820 with the network device 110 via both the first 131 and the second TRP 132. The communication via the second TRP 132 that is activated by the indication may include at least one of the following: transmission of SRS, reporting of CSI, PUCCH transmissions, monitoring of PDCCH, Hybrid Automatic Repeat reQuest (HARQ) process, PDSCH reception and PUSCH transmission.

After a time period, the network device 110 may determines 825 a further indication which is used to indicate deactivation of the second TRP 132. The network device 110 transmits 830 the further indication to the terminal device 120. Then the terminal device 120 determines 835 that the further indication indicates deactivation of the second TRP 132. Thus, the communication between the network device 110 and the terminal device 120 via the second TRP 132 will be terminated.

Still refer to FIG. 8. After the deactivation of the second TRP 132 at time 952, the terminal device 120 will monitor PDCCH on the CORESET 915 and will not monitor PDCCH on the CORESET 905, which is associated with the second TRP 132.

In some embodiments, the activation indication and/or the deactivation indication may be included in media access control (MAC) control element (CE). The indication can be sent via a control element from media access control layer, i.e., MAC CE, which may contain any of the following fields as shown in Table 3.

TABLE 3
MAC CE for activation and deactivation of a TRP

| | | |
|---|---|---|
| A/D | Cell ID | BWP ID |

| | |
|---|---|
| R | TRP ID |

The “A/D” field indicates whether the MAC CE is used to activate or deactivate indicated TRP(s), and this field may be set to “1” to indicate activation, otherwise it indicates deactivation. The “Cell ID” field, which may have a size of 5 bits, indicates the identity of the serving cell for which the MAC CE applies. The “BWP ID” field, which may have a size of 2 bits, indicates a downlink bandwidth part for which the MAC CE applies. The “TRP ID” field, which may have a size of 2 bits, indicates one or more TRP for which the MAC CE applies. The “R” field means reserved bits. It is to be noted that the MAC CE format shown in Table 3 is only for purpose of illustration without limiting the scope of the present disclosure. Other MAC CE formats are possible.

Alternatively or additionally, a timer for the second TRP 132 may be maintained by the terminal device 120 to determine the time period during which the second TRP 132 is activated.

During the timer period (from time 951 to time 952) when the second TRP 132 is activated, the terminal device 120 will not only monitor PDCCH on the CORESETs 913 and 914 (CORESETs 923 and 924 are dropped), but also monitor PDCCH on the CORESETs 903 and 904.

Any rule for dropping the search spaces overlapped in time may be applied per TRP rather than across different TRPs. For example, as schematically shown in FIG. 9, CORESETs 903, 913 and 923 may collide with each other since they are overlapped in time. The CORESETs 913 and 923 are associated with the first TRP131, and the CORESET 903 is associated with the second TRP132. For a plurality of CORSETs associated with one and the same TRP, the CORESET (and/or search spaces associated with the CORESET) with a lower priority needs to be dropped to resolve the collision. For example, although the CORESET 923, which is associated with the first TRP 131, may have a higher priority than the CORESET 903, the CORESET 923 need to be dropped since the CORESET 903 is associated with a different TRP, i.e. the second TRP 131 in this example.

In addition, ACK/NACK Resource Indicator (ARI) in a DCI is used to select a PUCCH to transmit the ACK/NACK bits for the DCI. When ACK/NACK bits according to different DCIs need to be transmitted in the same slot, the ARI for selecting the PUCCH transmission of ACK/NACK bits may be determined per TRP rather than across different TRPs. For example, as schematically shown in FIG. 9, for the first TRP 131, the final ARI 916 is determined based on the last DCI received on for example the CORESETs 913 and 914 which are associated with the first TRP131. For the second TRP 132, the final ARI 906 is determined based on the last DCI received on for example the CORESETs 903 and 904 which are associated with the second TRP132.

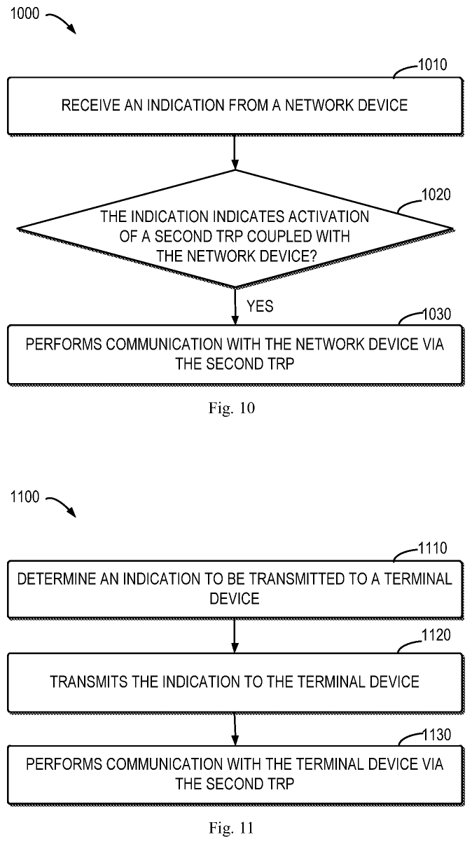

FIG. 10 shows a flowchart of an example method 1000 in accordance with some embodiments of the present disclosure. The method 1000 can be implemented at the terminal device 120 shown in FIG. 1. It is to be understood that the method 1000 may include additional blocks not shown and/or may omit some blocks as shown, and the scope of the present disclosure is not limited in this regard. For the purpose of discussion, the method 1000 will be described with reference to FIG. 1.

At block 1010, the terminal device 120 receives an indication from a network device 110. The terminal device 120 is communicating with the network device 110 via a first TRP 131 coupled with the network device 110.

At block 1020, the terminal device 120 determines whether the indication indicates activation of a second TRP 132 coupled with the network device 110. If the terminal device 120 determines the indication indicates activation of the second TRP 132, the process proceeds to block 1030. At block 1030, the terminal device 120 performs communication with the network device 110 via the second TRP 132.

In some embodiments, the indication is included in MAC CE.

FIG. 11 shows a flowchart of an example method 1100 in accordance with some embodiments of the present disclosure. The method 1100 can be implemented at the network device 110 shown in FIG. 1. It is to be understood that the method 1100 may include additional blocks not shown and/or may omit some blocks as shown, and the scope of the present disclosure is not limited in this regard. For the purpose of discussion, the method 1100 will be described with reference to FIG. 1.

At block 1110, the network device 110 determines an indication to be transmitted to a terminal device 120. The terminal device 120 is communicating with the network device 110 via a first TRP 131 coupled with the network device 110 and the indication indicates activation of a second TRP 132 coupled with the network device 110.

At block 1120, the network device 110 transmits the indication to the terminal device 120. At block 1120, the network device 110 performs communication with the terminal device 120 via the second TRP 131.

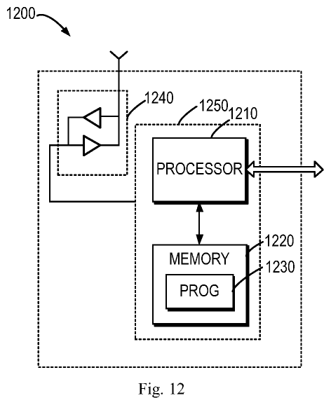

FIG. 12 is a simplified block diagram of a device 1200 that is suitable for implementing embodiments of the present disclosure. The device 1200 can be considered as a further example implementation of the network device 110 or the terminal device 120 as shown in FIG. 1. Accordingly, the device 1200 can be implemented at or as at least a part of the network device 110 or the terminal device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 3, 10 and 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1210 may form processing means 1250 adapted to implement various embodiments of the present disclosure.

The memory 1210 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1210 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2, 3, 8, 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method implemented at a terminal device, comprising:
determining a first link direction for a symbol, based on a first indication received via a first Transmission and Reception Point (TRP) coupled with a network device, the first link direction indicating a direction of a first transmission to be performed in the symbol between the terminal device and the network device via the first TRP;
determining a second link direction for the symbol, based on a second indication received via a second TRP coupled with the network device, the second link direction indicating a direction of a second transmission to be performed in the symbol between the terminal device and the network device via the second TRP; and
determining, based on the first and second link directions, a target transmission to be performed in the symbol from the first and second transmissions.

21. The method of claim 20, wherein determining the target transmission comprises:
in response to a priority of the first TRP being higher than that of the second TRP, determining the first transmission as the target transmission.

22. The method of claim 20, wherein determining the target transmission comprises:
in response to the first indication being comprised in downlink control information (DCI) to indicate a first resource and the second indication being comprised in Radio Resource Control (RRC) signaling to indicate a second resource, the first resource overlapping the second resource over the symbol,
determining the first transmission as the target transmission.

23. The method of claim 20, wherein the first link direction is different from the second link direction and determining the target transmission comprises:
in response to the first indication indicating a slot format of a slot including the symbol and the second indication indicating a resource, time domain of the resource including the symbol,
determining the first transmission as the target transmission.

24. The method of claim 20, wherein determining the target transmission comprises:
in response to the first indication being comprised in first DCI to indicate a first resource and the second indication being comprised in second DCI to indicate a second resource, the first resource overlapping the second resource over the symbol,
determining first timing information associated with the first DCI and second timing information associated with the second DCI; and
determining the target transmission based on the first and second timing information.

25. The method of claim 24, wherein determining the first timing information comprises determining the first timing information based on at least one of the following:
a starting symbol of the first DCI;
an ending symbol of the first DCI;
decoding latency of the first DCI;
a starting symbol of the first resource; and
duration of the first resource.

26. The method of claim 20, wherein the first indication being comprised in a first DCI to indicate downlink resources for the first transmission and the second indication being comprised in second DCI to indicate uplink resources for the second transmission, and the method further comprises:
in response to the first transmission being determined as the target transmission and starting of the second transmission being prior to starting of the first transmission, performing the second transmission on the uplink resource during a time period associated with the terminal device; and
performing reception on the downlink resource from the network device.

27. The method of claim 20, wherein both the first and second transmissions are uplink transmissions and determining the target transmission comprises:
determining a first information type of first information to be comprised in the first transmission and a second information type of second information to be comprised in the second transmission; and
determining the target transmission based on the first and second information types.

28. The method of claim 27, wherein determining the target transmission based on the first and second information types comprises:
in response to the first information type being of control information and the second information type being of data information, determining the first transmission as the target transmission.

29. (canceled)

30. (canceled)

31. A terminal device, comprising:
a processor; and
a memory coupled to the processing unit and storing instructions thereon, the instructions, when executed by the processing unit, causing the device to:
determine a first link direction for a symbol, based on a first indication received via a first Transmission and Reception Point (TRP) coupled with a network device, the first link direction indicating a direction of a first transmission to be performed in the symbol between the terminal device and the network device via the first TRP;
determine a second link direction for the symbol, based on a second indication received via a second TRP coupled with the network device, the second link direction indicating a direction of a second transmission to be performed in the symbol between the terminal device and the network device via the second TRP; and
determine, based on the first and second link directions, a target transmission to be performed in the symbol from the first and second transmissions.

32. The device of claim 31, wherein the instructions, when executed by the processing unit, cause the device to:
in response to a priority of the first TRP being higher than that of the second TRP, determine the first transmission as the target transmission.

33. The device of claim 31, wherein the instructions, when executed by the processing unit, cause the device to:
in response to the first indication being comprised in downlink control information (DCI) to indicate a first resource and the second indication being comprised in Radio Resource Control (RRC) signaling to indicate a second resource, the first resource overlapping the second resource over the symbol,
determine the first transmission as the target transmission.

34. The device of claim 31, wherein the first link direction is different from the second link direction and the instructions, when executed by the processing unit, cause the device to:
in response to the first indication indicating a slot format of a slot including the symbol and the second indication indicating a resource, time domain of the resource including the symbol,
determine the first transmission as the target transmission.

35. The device of claim 31, wherein the instructions, when executed by the processing unit, cause the device to:
in response to the first indication being comprised in first DCI to indicate a first resource and the second indication being comprised in second DCI to indicate a second resource, the first resource overlapping the second resource over the symbol,
determine first timing information associated with the first DCI and second timing information associated with the second DCI; and
determine the target transmission based on the first and second timing information.

36. The device of claim 35, wherein the instructions, when executed by the processing unit, cause the device to determine the first timing information based on at least one of the following:
a starting symbol of the first DCI;
an ending symbol of the first DCI;
decoding latency of the first DCI;
a starting symbol of the first resource; and
duration of the first resource.

37. The device of claim 31, wherein the first indication being comprised in a first DCI to indicate downlink resources for the first transmission and the second indication being comprised in second DCI to indicate uplink resources for the second transmission, and the instructions, when executed by the processing unit, further cause the device to:
in response to the first transmission being determined as the target transmission and starting of the second transmission being prior to starting of the first transmission, perform the second transmission on the uplink resource during a time period associated with the terminal device; and
perform reception on the downlink resource from the network device.

38. The device of claim 31, wherein both the first and second transmissions are uplink transmissions and the instructions, when executed by the processing unit, cause the device to:
determine a first information type of first information to be comprised in the first transmission and a second information type of second information to be comprised in the second transmission; and
determine the target transmission based on the first and second information types.

39. The device of claim 38, wherein the instructions, when executed by the processing unit, cause the device to:
in response to the first information type being of control information and the second information type being of data information, determine the first transmission as the target transmission.

40. A method implemented at a terminal device, comprising:
transmitting a first PUCCH associated with a first COREST based on a first DCI and a second PUCCH associated with a second COREST based on a second DCI;
wherein the first DCI is the last received DCI if a plurality of first DCIs are received; and the second DCI is the last received DCI if a plurality of second DCIs are received;
and the first PUCCH and the second PUCCH are transmitted in a same slot.

41. The method of claim 1, wherein the first PUCCH is associated with a first TRP and the second PUCCH is associated with the second TRP.
